(19) United States
(12) Patent Application Publication
(10) Pub. No.: US 2026/0212069 A1
(43) Pub. Date: Jul. 23, 2026

(54) DIGITAL TWIN SERVICE PROVIDING APPARATUS AND DIGITAL TWIN SERVICE PROVIDING METHOD

(71) Applicant: Gwangju Institute of Science and Technology, Gwangju (KR)

(72) Inventors: JIN WANG MOK, Gwangju (KR); JONG WON KIM, Gwangju (KR)

(73) Assignee: Gwangju Institute of Science and Technology, Gwangju (KR)

(21) Appl. No.: 19/228,686

(22) Filed: Jun. 4, 2025

(30) Foreign Application Priority Data
Jan. 22, 2025 (KR) 10-2025-0009441

(51) Int. Cl. G06F 30/20; G06F 30/13

(52) U.S. Cl. CPC G06F 30/20; G06F 30/13

(57) ABSTRACT

A digital twin service providing apparatus of the present disclosure includes at least one sub-component part that provides a digital twin service; a data storage part that stores first information necessary for providing a digital twin service; and a confidence calculation part that produces the confidence of the digital twin service.

### CROSS-REFERENCE TO RELATED APPLICATION

This application claims the benefit of Korean Patent Application No. 10-2025-0009441 filed on Jan. 22, 2025, in the Korean Intellectual Property Office, the entire disclosure of which is incorporated herein by reference for all purposes.

### BACKGROUND OF THE INVENTION

### Field of the Invention

The present disclosure relates to a digital twin service providing apparatus and a digital twin service providing method.

### Background of the Related Art

A digital twin is a technology that collects real-world data in real time, reflects the collected data into a virtual world, and implements the real-world data identically into the virtual world. The data may be stored and analyzed on a cloud-based platform to create various information.

A digital twin may be applied, thereby having advantages that can be used to improve an operational efficiency of the system and realize cost reduction, improve product quality and enhance competitiveness, and support a decision-making process through simulation. Despite those advantages, a decision-making error resulting from an incorrect simulation result may be fatal to corporate operations. Unreliable data has a risk of creating a contaminated model and creating an incorrect digital twin. Those issues must be addressed to enable accurate and reliable decision-making.

As a solution to the above problem, there is a technology that combines blockchain and digital twins. For example, as described in Publication Ser. No. 10/202,00081395, computer-implemented systems and methods for combining blockchain technology with digital twins has been proposed. By using the conventional technology, digital twin data is stored in a blockchain. Through this, the immutability of past information stored in the blockchain may be checked.

### CITATION LIST

### Patent Literature

Publication No. 1020200081395 Computer-implemented systems and methods for combining blockchain technology with digital twins

### SUMMARY OF THE INVENTION

The present disclosure provides a technology that can analyze a difference between a real-world and a digital twin.

The present disclosure provides a technology that provides a level of confidence of a digital twin.

The present disclosure provides a technology that can quantitatively analyze the confidence of a digital twin.

The present disclosure provides a technology that provides a confidence of a digital twin generated in response to an error in the digital twin, wherein the error includes a detection error in a real-world, a communication error between the real-world and the digital twin, and a creation error of the digital twin.

The present disclosure provides a technology that can provide the confidence of a digital twin in real time.

A digital twin service providing apparatus of the present disclosure may include at least one sub-component part that provides a digital twin service; a data storage part that stores first information necessary for providing a digital twin service; and a confidence calculation part that produces the confidence of the digital twin service.

The sub-component part may include a monitoring related sub-component part configured to continuously perform a process of detecting, collecting, and analyzing first data generated from a real-world; a mirroring related sub-component part that performs a process of synchronizing a real-world scene to a digital twin environment; and a modeling and simulation related sub-component part that builds a physical model of a digital twin and performs prediction by utilizing the physical model.

The first information stored in the data storage part may include the first data, second data produced by the sub-component part, a confidence, and metadata, and may be configured to provide the first information upon request from the confidence calculation part.

The confidence calculation part may quantitatively calculate the confidence of the digital twin service using third-party data to provide a confidence value.

The third data may include a local confidence, which is a confidence of an individual module that provides a digital twin service.

The third data may include a hyperparameter of an individual module, which is a weight of the individual module that provides a digital twin service.

The third data may include a hyperparameter of a blockchain, which is a weight corresponding to citing a blockchain to provide a digital twin service.

The third data may include a hyperparameter of a time difference, which is a weight for a difference between a time t at which a calculation request for the confidence value is generated and a time point τx at which a quantitative confidence is calculated.

The confidence value is produced using the following formula:

$${Confidence}_{t} = \frac{{\sum }_{x ∈ S} γ \cdot ( {w}_{x} \cdot {LC}_{x} \cdot {Δ}_{t} ( f ( t - {τ}_{x} ) ) )}{{\sum }_{x ∈ S} {w}_{x}} , with 0 \leq {Confidence}_{t} \leq 1$$

Here, S is a set of all modules to be considered to obtain a quantitative confidence, x is an individual module included in the set S, LCx (local confidence) is a quantitative confidence of a module x, ωx is a hyperparameter of an individual module as a weight for module x, y is a hyperparameter of a blockchain as a weight of a blockchain-based confidence assurance module, t is a timestamp when a request for calculating a quantitative confidence value is generated, Tx is a timestamp when the quantitative confidence of the module x is calculated, and Δt is a hyperparameter of a time difference as a weight for a difference between the time t when a request for calculating a quantitative confidence value is generated and the time point τx when the quantitative confidence is calculated.

A digital twin service providing method according to another embodiment may include a process of synchronizing a three-dimensional scene of an external reality environment for which a digital twin is targeted with a scene on the digital twin, as a mirroring process; a process of monitoring the external reality environment and any object within the external reality environment, as a monitoring process; and a process of performing a first step of building a physical model of a digital twin by using data collected from the mirroring, the monitoring, and the external real environment, and a second step of returning a prediction result of the model, as a modeling and simulation (M&S) process.

The digital twin service providing method may include a process of changing a state of the external reality environment, as a management process.

The digital twin service providing method may include a process of providing a confidence of a digital twin at any time point with a quantitative confidence value as a confidence assurance process.

The confidence value may be produced by using a first local confidence of a first individual module and a second regional confidence of a second individual module together, which are used to provide the digital twin service.

The production of the confidence value may include a hyperparameter of an individual module, which is a weight of the individual module that provides a digital twin service, a hyperparameter of a blockchain, which is a weight corresponding to citing a blockchain to provide a digital twin service, and a hyperparameter of a time difference, which is a weight for a difference between a time at which a request for calculating the confidence value is generated and a time point τx at which the local confidence is calculated.

According to the present disclosure, the confidence of a digital twin may be quantitatively provided. Various advantages thereof may be presented in more detail in the detailed description.

According to the present disclosure, the confidence of a digital twin may be checked at the present time.

### BRIEF DESCRIPTION OF THE DRAWINGS

FIG. 1 is a diagram for explaining a configuration of a digital twin service providing apparatus according to an embodiment.

FIG. 2 is a diagram for explaining a configuration of a digital twin service providing apparatus according to another embodiment.

FIG. 3 is a diagram specifically showing a specific embodiment of a digital twin service providing apparatus.

FIG. 4 is a graph of types of time parameters used in calculating confidence values and time coefficients corresponding thereto.

FIG. 5 is a flowchart specifically showing a method of calculating a confidence value.

FIG. 6 is a table showing calculation results of exemplary confidence values.

FIG. 7 is a diagram of a computing apparatus implementing a descriptor creation method and creation apparatus according to an embodiment of the present disclosure.

### DETAILED DESCRIPTION OF THE PREFERRED EMBODIMENT

Hereinafter, specific embodiments according to the present disclosure will be described in detail with reference to the accompanying drawings. However, the concept of the present disclosure is not limited to the embodiments to be described below, those skilled in the art who understand the concept of the present disclosure may easily propose other embodiments within the same concept by adding, changing, deleting, and modifying elements, which are also included in the concept of the present disclosure. In the description of the drawings, the same or similar elements are designated with the same numeral references regardless of the numerals in the drawings and redundant description thereof will be omitted. The suffixes “module” and “part” used for elements in the following description are used only to simplify the disclosure, and therefore do not have meanings or roles that distinguish elements from each other in themselves. In describing embodiments disclosed in this specification, the detailed description will be omitted when specific description for publicly known technologies to which the invention pertains is judged to obscure the gist of the present disclosure. The accompanying drawings are provided only for a better understanding of the embodiments disclosed herein and are not intended to limit technical concepts disclosed herein, and therefore, it should be understood that the accompanying drawings include all modifications, equivalents and substitutes within the concept and technical scope of the present disclosure. The terms including an ordinal number such as first, second, and the like may be used to describe various elements, but the elements should not be limited by those terms. The terms are used merely for the purpose to distinguish an element from another element. It will be understood that when an element is referred to as being “connected to” or “coupled to” another element, the element may be directly connected to or coupled to the other element or intervening elements may also be present. On the contrary, it will be understood that when an element is referred to being “directly connected” or “directly coupled” to another element, there are no intervening elements present. A singular representation may include a plural representation, unless the context clearly indicates otherwise. Terms “include” or “has” used herein should be understood that they are intended to indicate the existence of a feature, a number, a step, an element, a component or a combination thereof disclosed in the specification, and it may also be understood that the existence or additional possibility of one or more other features, numbers, steps, elements, components or combinations thereof are not excluded in advance. The operations, roles, functions, and actions of modules (parts) for performing the present disclosure may be performed by at least one processor. The at least one processor may be separated from one another in time and/or space. The processor may exemplify a computer.

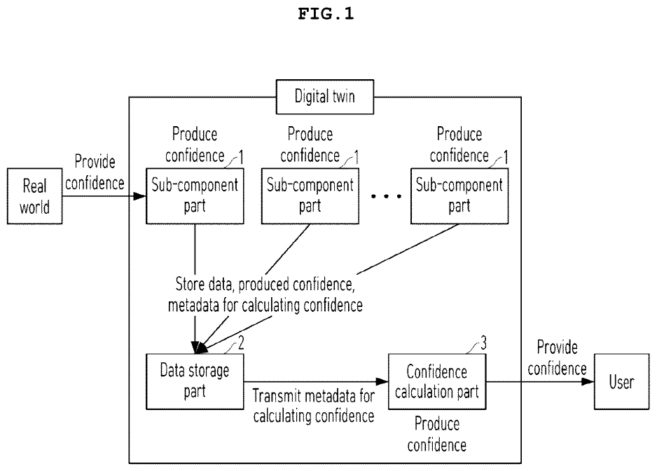

FIG. 1 describes a configuration of a digital twin service providing apparatus according to an embodiment.

FIG. 1 will be referenced. A digital twin service providing apparatus of the embodiment may include at least one sub-component part 1 configured to provide a digital twin service, a data storage part 2 that stores data, and a confidence calculation part 3 that produces the confidence of the provided digital twin service. The sub-component part 1 may include at least two units.

A real-world may be an external environment which is a target of a digital twin. The real-world may be a physical environment where data is generated. The data collected in the real-world may be provided to a component part that processes an input among sub-component parts that constitute a digital twin service providing apparatus. Accordingly, a change in a state of the real-world may be reflected in the digital twin. An apparatus that collects real-world data may include a variety of apparatuses, including a sensor, an IoT apparatus, and a camera.

A digital twin may include forming a virtual system or model based on data collected in the real-world, and operating the system and the model. The digital twin may perform mirroring and monitoring a state of a real-world, and a prediction or analysis based on the mirrored and monitored information.

The sub-component part may refer to a detailed element that constitutes the digital twin. The sub-component part may include a component that receives data collected from a real-world to produce a confidence and a confidence value. The confidence may refer to an absolute or relative degree of trustworthiness. The confidence value may refer to a value that quantitatively expresses a confidence. The confidence value will be described. For example, a temperature sensor in a real-world may have a temperature measurement error of 10%. According to this, when the real-world temperature is 10 degrees, the temperature measured by the temperature sensor may be measured to be 9 to 11. In this case, a confidence value of the temperature specified by the temperature sensor may be 90%. The confidence value may include an engineering error. The definition of the confidence may be applied to all components, modules, parts, and processors included in the implementation of a digital twin. The sub-component part may perform various processes that exemplify input processing, mirroring, monitoring, modeling, and simulation. The sub-component part may independently evaluate a confidence of data. The evaluated confidence may be stored together with metadata. In this case, it may be transferred to a separate data storage part and stored. The metadata may be data for data. Examples of the metadata may include a timestamp, a data structure, and container identification information.

The sub-component part may include individual component parts as follows.

The sub-component part may include a mirroring related sub-component. The mirroring related sub-component part may perform a process of synchronizing a three-dimensional scene of a real-world to a digital twin environment. In this case, real-world scene data may be created by a human operator or intelligent apparatus. The creation process may be performed periodically. Depending on the data collected during the monitoring process, it may include a dynamic modification of object information within a digital twin scene. For example, the mirroring related sub-component part may be a sub-component related to a process of synchronizing scenes of the real-world and the digital world.

The sub-component part may include a monitoring related sub-component. The monitoring related sub-component part may continuously detect, collect, and analyze data generated from the real-world or objects therewithin. In this case, the target data may be converted into a digital signal in the real-world and observed in real time or near real time. For example, the monitoring related sub-component part may be a sub-component related to a series of processes in which a change in the real-world is reflected as a virtual object within a digital twin.

The sub-component part may include modeling and simulation related sub-component parts. The modeling and simulation related sub-component part may build a physical model of a digital twin and perform a prediction using it. The modeling may refer to building a model to predict a structural change in the real-world within the digital twin. The simulation may refer to a model providing a predicted result for a given purpose. For example, the modeling and simulation related sub-component may be a sub-component part related to performing modeling and simulation.

The data storage part may store data, confidence, metadata, and the like produced by the sub-component part. The data storage part may provide data required by the confidence calculation part. The data storage part may efficiently manage data throughout the apparatus.

The confidence calculation part may produce a confidence of the apparatus, system, or method of the disclosure. The confidence calculation part may calculate a comprehensive confidence of a digital twin based on stored data and metadata. This process may ensure the confidence of the system and contribute to accurate determination. The produced confidence value may be provided to a user. It may be used as an important indicator to evaluate a confidence of a digital twin system. For example, a user may use the confidence value to determine a confidence level of a digital twin. For example, when a confidence value of a current digital twin is less than 50% as a threshold, the current digital twin may be determined as untrustworthy.

The user may be an end user who utilizes a result of a digital twin system. The user may perform a system operation, decision making, and a real-world situation management based on a confidence value provided by the confidence calculation part.

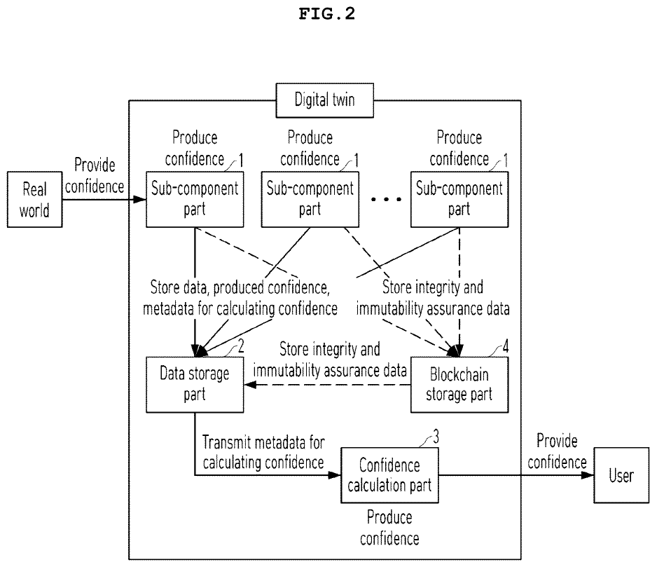

FIG. 2 describes a configuration of a digital twin service providing apparatus according to an embodiment.

FIG. 2 will be referenced. The digital twin service providing apparatus of FIG. 2 may further include a blockchain storage part 4 in addition to the digital twin service providing apparatus of FIG. 1. For parts without specific explanation, the explanation in FIG. 1 may be applied as they are.

A blockchain storage part may store data that must ensure integrity and immutability among the data of a digital twin on a blockchain network. It may perform a role of returning a hash value that can ensure the integrity of stored data. Through the blockchain storage part, the originality of data may be ensured, and the accuracy of a quantitative confidence may be improved by considering whether a blockchain is stored when calculating a confidence. In particular, the blockchain storage part of the embodiment has a unique feature in that the blockchain storage part acts as a factor in calculating a quantitative confidence, not just comparing hash values.

Hereinafter, a digital twin service providing apparatus and providing method including the blockchain storage part and the provision of a blockchain service therethrough will be described. An embodiment without the blockchain storage part would also be possible.

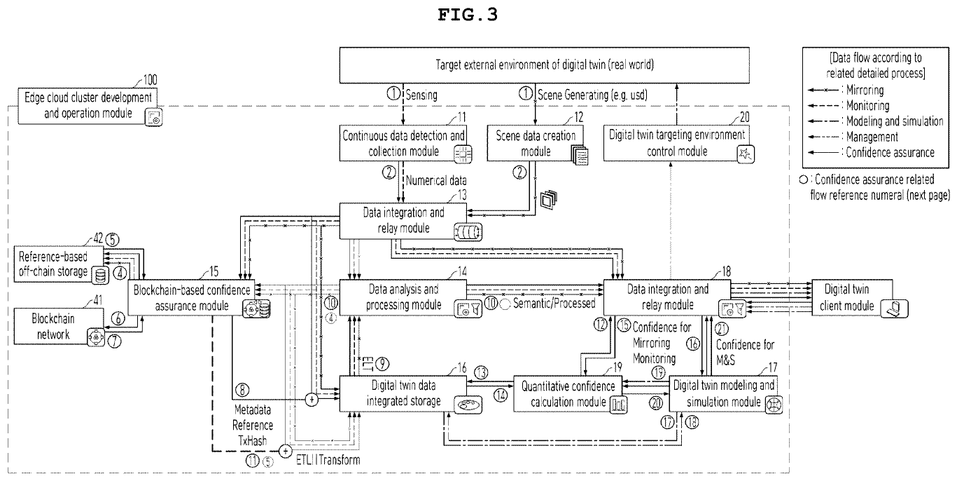

FIG. 3 describes a specific embodiment of a digital twin service providing apparatus.

FIG. 3 will be referenced. The real-world may be defined as a target external environment of a digital twin. A user may be defined as a digital twin client module. The digital twin client module may be a computer program or a set of computer programs with which a user using a service may interact for mirroring, monitoring, modeling and simulation, management, and confidence check. The user may be a person who uses a digital twin service.

An edge cloud cluster development and operation module 100 may be a digital twin service providing apparatus. Specifically, the edge cloud cluster development and operation module 100 may be a module in which an operator operates a digital twin service provider. More specifically, it may be a set of computer programs that develop a set of computer programs that constitute the edge cloud cluster development and operation module 100 and the digital twin service providing apparatus, and operate them for the purpose of high flexibility and high availability.

The data storage part 2 may include a digital twin data integrated storage 16. The confidence calculation part 3 may include a quantitative confidence calculation module 19. The blockchain storage part 4 may include a blockchain network 41, a blockchain-based confidence assurance module 15, and a reference-based off-chain storage 42. The sub-component part 1 may include a number of modules to provide a digital twin service.

A specific configuration of the embodiment will be described in detail.

A continuous data detection and collection module 11 may be an apparatus or a set of apparatuses that continuously detect and collect an external environment that is a target of a digital twin, a state of any object within the environment, and information that can be converted into a digital signal or the like. For example, it may include IoT sensors/devices such as a temperature and humidity sensor, an UWB or the like.

A scene data creation module 12 may be an operator or an apparatus or a set of apparatuses capable of intelligent processing that creates data corresponding to a scene of an external environment that is a target of a digital twin. For example, it may include a three-dimensional information providing apparatus and a three-dimensional scene creation module. By means of the creation module, data corresponding to a change in a scene of an external environment may be created at any period or intermittently.

A data integration and relay module 13 may include a processor, a computer program, and/or a set of programs that perform a function of integrating and relaying data configured with any different periods and types. For example, it may include Kafka+Kafka Connect+Kafka Stream.

A data processing and analysis module 14 may include a processor, a computer program, or a set of programs that perform a function of processing, analyzing, and processing data received from the data integration and relay module. For example, it may include Spark+Scikit-learn+customized functions.

A blockchain-based confidence assurance module 15 may include a processor, a computer program, and/or a set of programs that can ensure a confidence for any data by utilizing a reference-based off-chain storage for lightweighting of a blockchain and a blockchain network.

The reference-based off-chain storage 42 may include a storage apparatus, a processor, a computer program, a plurality of storage apparatuses, and/or a set of programs that store original data for efficient operation of a blockchain network, return a unique reference value, and thereby access raw data. For example, it may include an IPFS (CID), which returns a CID as a reference value.

The blockchain network 41, which is a distributed ledger storage system configured with an any consensus algorithm, may include a network system configured with a processor, a number of calculation apparatuses, and/or a computer program to ensure the integrity and immutability of data and intelligently process any shared procedural contracts.

The digital twin data integrated storage 16 may include a processor, a storage apparatus, a computer program, a plurality of storage apparatuses, and/or a set of programs that perform a function of integrating and storing data related to a digital twin for easy management and access.

A digital twin operation module 18 may include a processor, a computer program, and/or a set of computer programs that perform an overall operation function including mirroring, monitoring, modeling and simulation, and management processes of a digital twin, and provide a digital twin environment and confidence assurance information thereof at a request of a client.

A digital twin modeling and simulation module 17 may include a processor, a computer program, and/or a set of computer programs that create a model capable of performing a prediction through data of a digital twin and other target external environments (modeling), and predict a result for any time point or situation using such a model (simulation).

A quantitative confidence calculation module 19 may include a processor, a computer program, and/or a set of computer programs that provide a quantitative confidence for a digital twin at any time point by considering confidences of related sub-modules, whether a blockchain is stored, and the like to ensure a confidence of the digital twin.

A digital twin targeting environment control module 20 may include a processor, a machine apparatus, a computer program, a plurality of machine apparatuses, and/or a set of computer programs that perform a function of controlling a device and apparatus that can change a state on a target external environment according to a request from a digital twin client (user) or intelligent processing of the digital twin.

A digital twin service providing method provided by the apparatus of FIG. 3 will be described.

The digital twin service providing method may include a mirroring process, a monitoring process, a modeling and simulation process, a management process, and a confidence assurance process. The mirroring process, monitoring process, modeling and simulation process, management process, and confidence assurance process specify a flow of each process in an upper right corner of FIG. 3.

The mirroring process may refer to synchronizing a three-dimensional scene of a digital twin targeting external real environment with a scene on the digital twin. The mirroring process may include a static modification that creates digital twin scene data for a scene in an external real environment at any intervals, either by a human operator or a machine apparatus capable of intelligent processing and a computer program, and a dynamic modification that modifies any object information within the scene based on data detected and collected during the monitoring process.

The monitoring process may be generated as a continuous flow in an “external reality environment” for which a digital twin is targeted or “any object within the external reality environment.” Monitoring may refer to observing a signal that can be converted into a digital form. The monitoring process may be performed by a machine and apparatus that continuously detects and collects the signal. The monitoring process may refer to observing a change in a target external environment in real time or in near real time at short intervals through the apparatus or a plurality of apparatuses.

The monitoring process may refer to visualizing in any way in the edge cloud cluster development and operation module. This may primarily refer to continuously observing a state of “any object” and its corresponding “virtual twin object” that is a source of data detected and collected by the apparatus within a digital twin environment.

The modeling & simulation (M&S) process may include modeling and simulation. The “modeling” may refer to building a physical model of a digital twin based on data collected from the aforementioned mirroring and monitoring and data provided from a client or digital twin operation module for an external real environment. The “simulation” may refer to an act of returning a predicted result of a model built for any purpose.

The management process may be performed by a machine and apparatus that can be controlled to change a state of a digital twin targeting external real environment. The apparatus may include a processor and/or a computer program. The management process may refer to an act of changing a state of an external real environment by controlling an appropriate machine and apparatus through intelligent determination of a client, which is a user of a digital twin, or a digital twin operation module.

The digital twin process may be performed through the four processes. However, a digital twin as a performance result has a problem in that its confidence is not ensured. For example, it may be checked that a digital twin is completely consistent with a real-world. In an extreme example, a digital twin may be implemented completely differently from a real-world.

The confidence assurance process may provide a quantitative confidence in a state of a digital twin to ensure the confidence of the digital twin. The confidence assurance process may utilize a blockchain-based confidence assurance technique. The confidence assurance process may provide the confidence of the digital twin state at any time point. Through this, the confidence of the digital twin may be ensured at any time point. For example, the confidence assurance process may be performed so as to provide quantitative information on a confidence that is 95% (quantitatively) consistent with a real-world.

A specific flow of a digital twin service providing method according to an embodiment will be described. The process will be described by using circled numbers indicated in FIG. 3. At least one of the following steps may not be performed.

1. An external environment for which a digital twin is targeted or data for the environment is created and collected. Monitoring may include continuous detection and collection of information that can be converted into a state and digital signal of any object. Mirroring may create scene data for an element such as any object within a target external environment and an external environment.

2. The detected and collected raw data and sets thereof may be transmitted to a metadata and confidence data integration and collection module predefined by a digital twin operator. Multiple sub-modules may be configured to detect and collect raw data for confidence calculation, and intelligent processing may be performed depending on the sub-modules.

The metadata may include a number of examples as follows.

(1) Timestamp: A time at which metadata and data are transmitted. For example, it may include “timestamp”: “2024-11-07T12:34:56Z”.

(2) Data structure: A description of structure of response data. For example, it may include “data schema”:“JSON”.

(3) Container identification information: Information that can identify a container. For example, it may include “container_id”: “container 1234”.

(4) Container_type: A classification of a role of container (a type of sub-component part). For example, it may include “container_type”: “mirroring” (or specify a more specific type). A type of container may vary depending on a policy and may be distinguished through container identification information.

(5) Related resource state: State information such as CPU, memory, and the like. For example, it may include “cpu_usage”: “55.3%”, “memory_usage”: “2.4 GB”. Through the resource state, comparison with the previous state may be allowed, and the information items may be used to calculate a local confidence (LC) of each module and sub-component part.

(6) Local confidence: It may be a confidence internally calculated by each individual processing unit (similar to the container). A local confidence may or may not be obtained depending on a policy. The local confidence may be calculated later by a confidence calculation part. However, it may include a configuration in which information items for calculating a quantitative confidence for a state of a digital twin are stored together as metadata, and a confidence calculation part finally calculates quantitatively. For example, a confidence for a “state” such as “local confidence”: “89.1” container may be taken as an example.

(7) Output confidence (Opt.): If this sub-component part produces an output value, a confidence for the output value may be optionally included. (In the case of an artificial intelligence model). For example, it may include “validation loss”:“0.02”, “mAP@50”:“0.995”.

(8) Optional data: Optional data may vary depending on a type of container, and the like. For example, “tags”: [“sensor”,“temperature”,“video”, “etc.” ]: Tags may be added according to a policy. “processing_time_ms”:150: Time taken for processing (separated from timestamp). “sensor config” or “sensor spec”: {“sampling rate”: “10 Hz”, “threshold”: “75” }. “sensor state”: {“running”, “stop”, or a description of a state}. “log”: log information for debugging, or the like as an example.

(9) Other required metadata items. For example, it may include “version”:“1.0.0”: Version information for digital twin control, “error_code”:“E NONE”: Error code, and “checksum”:“281ef2 . . . ”: Checksum data for data integrity verification.

(10) Actual data payload. For example, it may include, e.g. “data_payload”: { . . . actual data . . . }.

3. In order to perform an efficient operation of a digital twin while simultaneously performing blockchain-based confidence assurance processing, each data and metadata stored therewith, such as a confidence, may be relayed to an appropriate module. The relay processing may separate “confidence assurance and confidence calculation” and “digital twin operation,” which may improve operational efficiency in cases such as real-time processing. In this case, a confidence may be calculated by considering whether it is stored in a blockchain, so it may be appropriate for real-time data to have a relatively low confidence.

4. Data requiring blockchain-based confidence assurance may be appropriately disposed and processed according to a type of data and operation policy, and related metadata may be added and stored together in the reference-based off-chain storage.

5. The data in the step 4 may be stored and then reference data for the data may be returned. For example, it may include a content ID (CID) of an IPFS.

6. The reference data returned in the step 5 for the data in the step 4 may be stored in a blockchain network. This step may be performed on-chain.

7. A transaction in the step 6 may be stored in a blockchain network, and then a transaction hash (TxHash) may be returned.

8. The data in the step 4, the reference data returned in the step 5, the transaction hash returned in the step 7, and metadata according to an operation policy may be stored together in an integrated storage.

9. The data with an ensured confidence, which is stored in the integrated storage, may be moved to a data analysis and processing module along with its metadata to perform analysis and processing thereon.

10. As a result of analyzing and processing the data in the step 9, a “confidence” corresponding thereto and “metadata” according to an operation policy may be moved to a digital twin operation module for an efficient operation. At the same time, it may move to the module to ensure a blockchain-based confidence.

11. For the data in the step 10, blockchain-based confidence assurance processing corresponding to the steps 4 to 7 may be performed and stored in the integrated storage as in the step 8.

12. Data may be transmitted and processed from the digital twin operation module to calculate the confidence of monitoring and mirroring at any time point. In this case, depending on an operation policy, it may be requested by metadata such as a reference or transaction hash of data rather than raw data.

13. The calculated confidence and its data and metadata may be stored in the integrated storage for future use. This process may be optionally included depending on an operation policy.

14. By checking that data storage including a confidence is completed in the integrated storage and receiving the stored data once more, the reliability of the calculated confidence may be strengthened by verifying the integrity of the data. This process may be optionally included depending on an operation policy. When this process is included, if the integrity of the transmitted data is not ensured, retries may be performed as many times as required by the operation policy.

15. The calculated confidence may provide a quantitative confidence for a monitoring and mirroring process at any time point.

16. A modeling and simulation request for any data may be generated based on a user's request or intelligent processing of a digital twin. In other cases, modeling and simulation may be performed based on data collected, processed, and stored at any temporal interval.

17. In the case of modeling, data required for modeling and confidence assurance data corresponding thereto may be requested from the integrated storage. In the case of simulation, a model to be used for the simulation and confidence assurance data corresponding thereto may be requested from the integrated storage.

18. The data requested in the step 17 may be returned to the modeling and simulation module.

19. In addition to a “modeling and simulation result” and “use data” and “confidence assurance metadata” corresponding thereto, a “confidence value” calculated by the M&S module may be requested for calculation from the confidence calculation module.

20. In the step 19, the calculated confidence may be returned to the modeling and simulation module.

21. The calculated confidence may quantitatively provide a confidence on a result of an M&S process utilizing a digital twin.

As a result, a quantitative confidence may be transmitted to a client module. A user may use quantitative confidence information to assist in decision making. For example, when the confidence is high, he or she may trust the information in the digital twin to make a decision. Conversely, when the confidence is low, he or she may only refer to the information in the digital twin and investigate other information before making a decision.

Hereinafter, a method of producing a confidence and a confidence value will be described in detail.

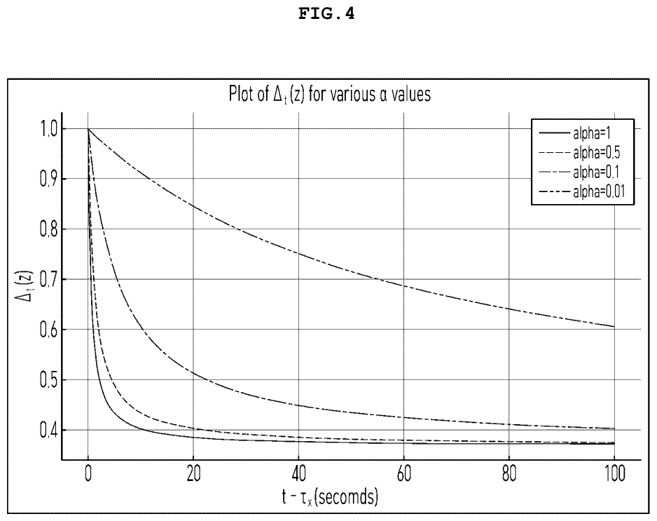

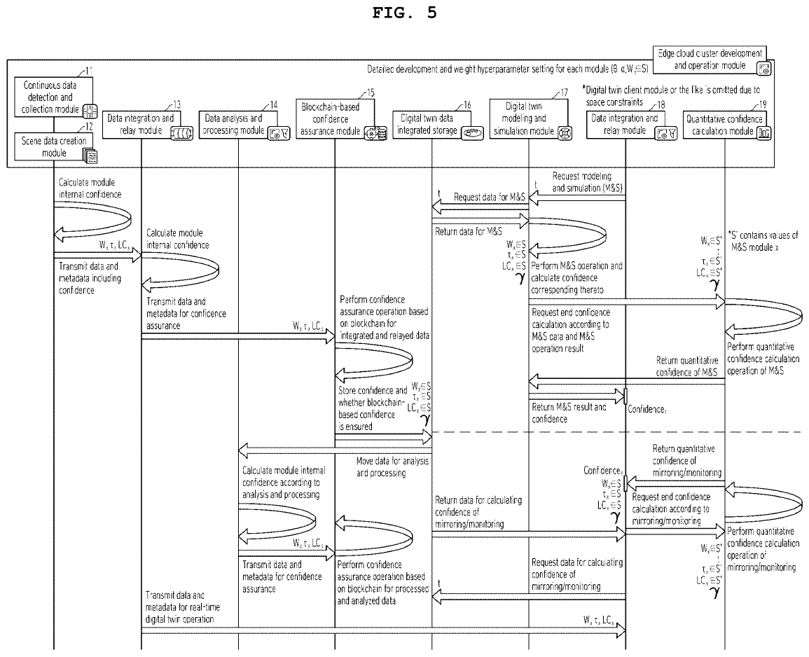

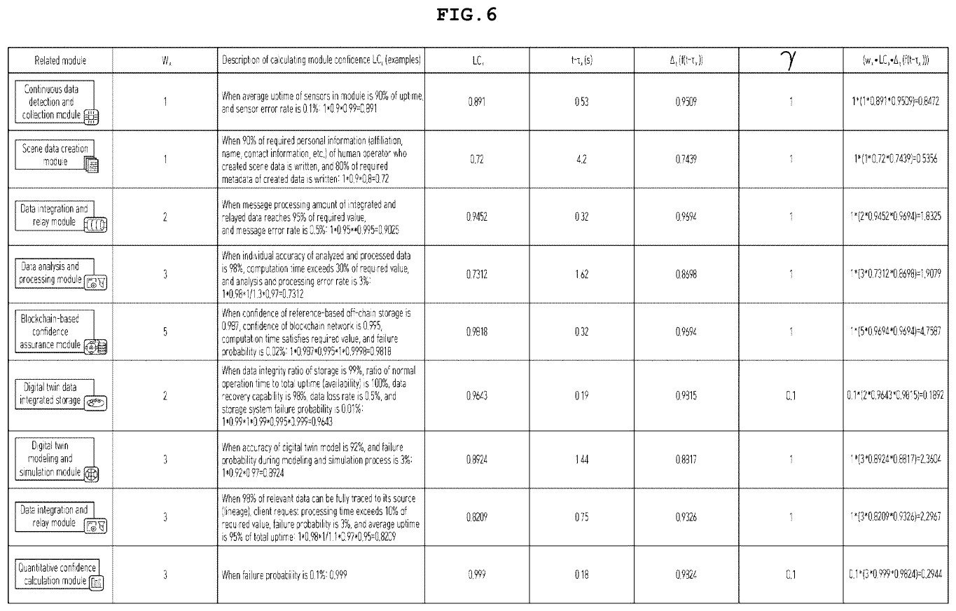

FIG. 4 is a graph of types of time parameters used in calculating confidence values and time coefficients corresponding thereto. FIG. 5 is a flowchart specifically showing a method of calculating a confidence value. FIG. 6 is a table showing calculation results of exemplary confidence values.

FIGS. 4 to 6 will be referenced. A confidence may refer to an overall confidence of the digital twin. The confidence may be calculated by reflecting a confidence of at least one individual module. The confidence may be calculated by reflecting confidences of all individual modules. The confidence of the individual module has been described by using a temperature sensor as an example.

The confidence may be performed using Mathematical Expression 1.

$$[ Mathematical Expression 1 ]$$

$${Confidence}_{t} = \frac{{\sum }_{x ∈ S} γ \cdot ( {w}_{x} \cdot {LC}_{x} \cdot {Δ}_{t} ( f ( t - {τ}_{x} ) ) )}{{\sum }_{x ∈ S} {w}_{x}} , with 0 \leq {Confidence}_{t} \leq 1$$

Each element of the Mathematical Expression 1 will be described.

S may be a set of all modules that should be considered to obtain a quantitative confidence.

x may refer to an individual module included in the set S. For example, it may include all elements involved in the implementation of a digital twin.

LCx (local confidence) may be a value at a predetermined time point as a quantitative confidence of module x. The LCx may be greater than or equal to 0 and less than or equal to 1.

ωx, which is a weight for module x, may be a hyperparameter of an individual module. The hyperparameter of the individual module may be greater than or equal to 0 and less than or equal to 1. The hyperparameter of the individual module may indicate a degree to which the individual module affects the confidence (confidence of the digital twin). For example, when an individual module has a large impact on the digital twin, the hyperparameter of the individual module may be large.

γ, which is a weight of a blockchain-based confidence assurance module, may be a hyperparameter of a blockchain corresponding to the use of the blockchain. The hyperparameter of the blockchain may be greater than or equal to 0 and less than or equal to 1. When data or the like is stored in a blockchain, the blockchain hyperparameter may be set to 1. When data or the like is not stored in a blockchain, the blockchain hyperparameter may be set to a value greater than or equal to 0 and less than 1.

t may be a timestamp at which a request for calculating a quantitative confidence value is generated. In other words, it may be a timestamp at a target time point.

τx may be a timestamp at which a quantitative confidence of module x is calculated.

Δt, which is a weight for a difference between a time t when a request for calculating a quantitative confidence value is generated and a time point τx at which a quantitative confidence is calculated, may be a hyperparameter of a time difference. The hyperparameter of the time difference may be given by Mathematical Expression 2.

$$\text{?} ( z ) = exp ( \frac{- z}{\text{?} + 1} ) , z = α \cdot ( t - \text{?} ) \qquad [ Mathematical Expression 2 ]$$

$$\text{?} \text{indicates text missing or illegible when filed}$$

In the Mathematical Expression 2, a parameter z may be a predetermined function whose factor is a difference between a time t when a request for calculating a quantitative confidence value is generated and a time point τx at which a quantitative confidence is calculated. In an embodiment, the parameter z may be defined as a value obtained by multiplying a predetermined coefficient α by a difference between a time t when a request for calculating a quantitative confidence value is generated and a time point τx at which a quantitative confidence is calculated. FIG. 4 presents a result value of Mathematical Expression 2 according to varying coefficients. A result value of Mathematical Expression 2 may present a result value of the hyperparameter of the time difference.

The confidence may be calculated by an operation of the Mathematical Expressions 1 and 2.

FIG. 5 describes a process of calculating the confidence value according to the providing method presented in FIG. 3.

As an example, each individual module may calculate its own local confidence. For example, in the case of a temperature sensor, it may be determined in advance according to a measurement error of the temperature sensor. As another example, a local confidence may be determined through a statistical analysis of past information, or an analysis of true and current values. Various other methods may be used.

Then, LCx (local confidence), ωx (hyperparameter of individual module), and Tx (timestamp when LCx is calculated) may be sent externally from the individual module. The digital twin data integrated storage 16 may store data required for calculating a confidence value. The quantitative confidence calculation module 19 may determine a confidence of a digital twin using the Mathematical Expressions 1 and 2 using the stored data. The confidence may be transmitted to the outside.

It can be seen that the confidence value obtained illustratively in FIG. 6 is 65.31%. It can be seen that the hyperparameter of the individual module of the blockchain-based confidence assurance module 15 is the largest. This may denote that the confidence of a digital twin is improved by a blockchain. It can be seen that the scene data creation module 12 has the largest difference between a time t when a request for calculating a quantitative confidence value is generated and a time point τx at which a quantitative confidence is calculated. This results in the hyperparameter of the time difference becoming smaller. Accordingly, it can be seen that a confidence of a digital twin decreases as a time difference increases.

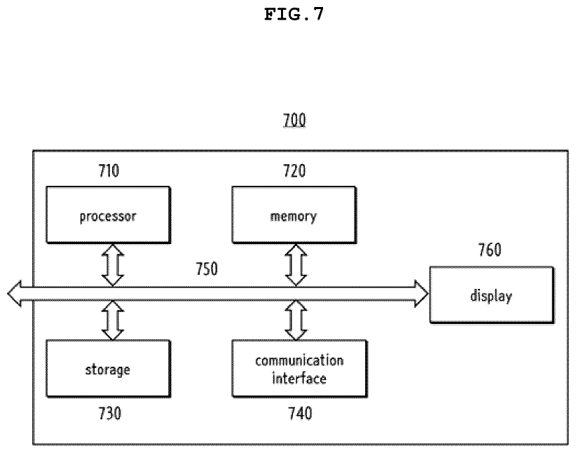

FIG. 7 is a diagram of a computing apparatus implementing a descriptor creation method and creation apparatus according to an embodiment of the present disclosure.

FIG. 7 shows a computing apparatus implementing a descriptor creation method and creation apparatus according to an embodiment of the present disclosure.

An embodiment of the present disclosure described by FIGS. 1 to 6 may be implemented by a computing apparatus 700 operating by at least one processor.

The computing apparatus 700 may include a processor 710, a memory 720, a storage 730, a communication interface 740, a system interconnect 750, and a display 760.

The processor 710 includes a central processing unit (CPU), a micro processor unit (MPU), a micro controller unit (MCU), a graphics processing unit (GPU), and an application processing unit (APU).

The memory 720 interacts with the processor 710 to store data so as to allow a program to be executed efficiently and perform a function of quickly accessing necessary information. The memory 720 includes at least one of a register, a cache memory, a main memory, a read-only memory, a virtual memory, and a non-volatile memory.

The storage 730 serves to permanently store and manage data. The storage preserves data even after a computing system is turned off or rebooted, and is used to store an operating system, an application, a user file, and the like. The storage 730 includes at least one of a hard disk drive (HDD), a solid-state drive (SSD), an optical disk, a network storage, and a cloud storage.

The communication interface 740 provides a path for sending and receiving data between various apparatuses inside and outside the computing system. The communication interface 740 may support at least one communication method among Universal Serial Bus (USB), Peripheral Component Interconnect Express (PCIe), Serial ATA (SATA), Ethernet, Wi-Fi, Thunderbolt, and High-Definition Multimedia Interface (HDMI).

The system interconnect 750 serves to exchange data and signals between various elements within the computing system. The system interconnect 750 may support at least one method among a bus, a point-to-point, a crossbar switch, and a network-on-chip (NoC).

The display 760, which is an output apparatus of a computing system, performs a function of providing visual information to the user.

By the above-described configuration, a program according to an embodiment of the present disclosure is executed based on instructions executed by the processor 710, and may be stored in the memory 720 or storage 730.

A method according to the foregoing embodiment of the present disclosure may be implemented in a form of program commands that can be executable through various types of computer elements and recorded in a computer-readable storage medium. The computer-readable recording medium may include program instructions, data files, data structures, and the like individually or in combination thereof. The program commands stored on the computer-readable recording medium may be specially designed and configured for an embodiment of the present disclosure, or may be known and available to those skilled in the art in the computer software field. The computer-readable recording medium includes hardware configured to store and execute program commands, such as a magnetic recording medium such as a hard disk, a floppy disk, and a magnetic tape, an optical recording media such as a CD-ROM and a DVD, a magneto-optical medium such as a floptical disk, a ROM, a RAM, and a flash memory. The program commands include machine language codes created by a compiler and high-level language codes that can be executed on a computer using an interpreter. The hardware may be configured to operate as one or more software modules in order to process a method according to the present disclosure, and vice versa.

A method according to an embodiment of the present disclosure may be executed in an electronic apparatus in a form of program commands. The electronic apparatus includes a portable communication apparatus such as a smartphone or a smart pad, a computer apparatus, a portable multimedia apparatus, a portable medical device, a camera, a wearable apparatus, and a home appliance.

A method according to an embodiment of the present disclosure may be provided as included in a computer program product. The computer program product may be traded as a commodity between a seller and a buyer. The computer program product may be distributed in a form of a device-readable recording medium or online through an application store. In the case of online distribution, at least part of the computer program product may be at least temporarily stored or temporarily created in a storage medium, such as a manufacturer's server, a server of an application store or a memory of a relay server.

Each element, such as a module or a program according to an embodiment of the present disclosure may be configured with a single or a plurality of sub-elements, and some of those sub-elements may be omitted or other sub-elements may be further included. Some elements (modules or programs) may be integrated into a single entity to perform the same or similar functions performed by each of the elements prior to the integration. Operations performed by a module, a program or another element according to an embodiment of the present disclosure may be executed sequentially, in parallel, repeatedly, or heuristically, or at least some operations may be executed in a different order, omitted, or other operations may be added.

The foregoing description of the present disclosure is for illustrative purposes, but it will be apparent to those skilled in the art to which the present disclosure pertains that the present disclosure can be easily modified in other specific forms without departing from the technical concept and essential characteristics thereof. Therefore, it should be understood that embodiments described above are merely illustrative but not restrictive in all aspects. For example, each element described as a single entity may be distributed and implemented, and likewise, elements described as being distributed may also be implemented in a combined manner.

The scope of the present disclosure is defined by the appended claims, and all changes or modifications derived from the meaning and range of the claims and equivalents thereof should be construed to be embraced by the scope of the present disclosure.

According to the present disclosure, a quantitative confidence of a digital twin may be determined through a degree of contribution of each module in a digital twin, a confidence of each module, problem generation tracking in a module, and reflection of an operating policy. The quantitative confidence may be utilized as a reference for decision-making using a digital twin. For example, in operating a smart factory, whether to implement the smart factory in a real-world may be determined by reflecting a result of execution of the digital twin. As a result, if the digital twin has a high confidence, the success of the smart factory in the real-world may be increased.

### DESCRIPTION OF SYMBOLS

1: Sub-component part
2: Data storage part
3: Confidence calculation part
4: Blockchain storage part

What is claimed is:

1. A digital twin service providing apparatus, the apparatus comprising:
at least one sub-component part that provides a digital twin service;
a data storage part that stores first information necessary for providing a digital twin service; and
a confidence calculation part that produces the confidence of the digital twin service,
wherein the sub-component part comprises:
a monitoring related sub-component part configured to continuously perform a process of detecting, collecting, and analyzing first data generated from a real-world;
a mirroring related sub-component part that performs a process of synchronizing a real-world scene to a digital twin environment; and
a modeling and simulation related sub-component part that builds a physical model of a digital twin and performs prediction by utilizing the physical model,
wherein the first information stored in the data storage part includes the first data, second data produced by the sub-component part, a confidence, and metadata, and is configured to provide the first information upon request from the confidence calculation part, and
wherein the confidence calculation part quantitatively calculates the confidence of the digital twin service using third-party data to provide a confidence value.

2. The apparatus of claim 1, wherein the third data includes a local confidence, which is a confidence of an individual module that provides a digital twin service.

3. The apparatus of claim 1, wherein the third data includes a hyperparameter of an individual module, which is a weight of the individual module that provides a digital twin service.

4. The apparatus of claim 1, wherein the third data includes a hyperparameter of a blockchain, which is a weight corresponding to citing a blockchain to provide a digital twin service.

5. The apparatus of claim 1, wherein the third data includes a hyperparameter of a time difference, which is a weight for a difference between a time t at which a calculation request for the confidence value is generated and a time point τx at which a quantitative confidence is calculated.

6. The apparatus of claim 1, wherein the confidence value is produced using the following formula:
$${Confidence}_{t} = \frac{{\sum }_{x ∈ S} γ \cdot ( {w}_{x} \cdot {LC}_{x} \cdot {Δ}_{t} ( f ( t - {τ}_{x} ) ) )}{{\sum }_{x ∈ S} {w}_{x}} , with 0 \leq {Confidence}_{t} \leq 1$$
wherein S is a set of all modules to be considered to obtain a quantitative confidence, x is an individual module included in the set S, LCx (local confidence) is a quantitative confidence of a module x, ωx is a hyperparameter of an individual module as a weight for module x, γ is a hyperparameter of a blockchain as a weight of a blockchain-based confidence assurance module, t is a timestamp when a request for calculating a quantitative confidence value is generated, τx is a timestamp when the quantitative confidence of the module x is calculated, and Δt is a hyperparameter of a time difference as a weight for a difference between the time t when a request for calculating a quantitative confidence value is generated and the time point τx when the quantitative confidence is calculated.

7. A digital twin service providing method, the method comprising:
a process of synchronizing a three-dimensional scene of an external reality environment for which a digital twin is targeted with a scene on the digital twin, as a mirroring process;
a process of monitoring the external reality environment and any object within the external reality environment, as a monitoring process;
a process of performing a first step of building a physical model of a digital twin by using data collected from the mirroring, the monitoring, and the external real environment, and a second step of returning a prediction result of the model, as a modeling and simulation (M&S) process;
a process of changing a state of the external reality environment, as a management process; and
a process of providing a confidence of a digital twin at any time point with a quantitative confidence value as a confidence assurance process, and
wherein the confidence value is produced by using a first local confidence of a first individual module and a second regional confidence of a second individual module together, which are used to provide the digital twin service.

8. The method of claim 7, wherein the production of the confidence value comprises at least one of:
a hyperparameter of an individual module, which is a weight of the individual module that provides a digital twin service;
a hyperparameter of a blockchain, which is a weight corresponding to citing a blockchain to provide a digital twin service; and
a hyperparameter of a time difference, which is a weight for a difference between a time at which a request for calculating the confidence value is generated and a time point τx at which the local confidence is calculated.

9. The method of claim 7, wherein the confidence value is produced using the following formula:
$${Confidence}_{t} = \frac{{\sum }_{x ∈ S} γ \cdot ( {w}_{x} \cdot {LC}_{x} \cdot {Δ}_{t} ( f ( t - {τ}_{x} ) ) )}{{\sum }_{x ∈ S} {w}_{x}} , with 0 \leq {Confidence}_{t} \leq 1$$
wherein S is a set of all modules to be considered to obtain quantitative confidence, x is an individual module included in the set S, LCx (local confidence) is a quantitative confidence of a module x, ωx is a hyperparameter of an individual module as a weight for module x, γ is a hyperparameter of a blockchain as a weight of a blockchain-based confidence assurance module, t is a timestamp when a request for calculating a quantitative confidence value is generated, τx is a timestamp when the quantitative confidence of the module x is calculated, and Δt is a hyperparameter of a time difference as a weight for a difference between the time t when a request for calculating a quantitative confidence value is generated and the time point τx when the quantitative confidence is calculated.
